(19) United States
(12) Patent Application Publication
(10) Pub. No.: US 2018/0131053 A1
(43) Pub. Date: May 10, 2018

(54) METHOD AND DEVICE FOR TEMPERATURE REGULATION OF BATTERY CELLS AND VEHICLE

(71) Applicant: Robert Bosch GmbH, Stuttgart (DE)

(72) Inventor: Uwe Knappenberger, Muehlacker (DE)

(21) Appl. No.: 15/565,420

(22) PCT Filed: Mar. 15, 2016
(86) PCT No.: PCT/EP2016/055600

§ 371 Date: Oct. 9, 2017

(30) Foreign Application Priority Data
Apr. 10, 2015 (DE) 10 2015 206 392.5

(51) Int. Cl. H01M 10/625

(52) U.S. Cl. CPC H01M 10/625

(57) ABSTRACT

The invention relates to a method for the temperature regulation of battery cells (100₁, . . . 100₃; 100″₁, . . . 100″₃) which each comprise a first electrode (110₁, . . . 110₃) formed as a first housing shell and a second electrode (120₁, . . . 120₃) formed as a second housing shell, and which are electrically connected to one another via the electrodes (110₁, . . . 110₃, 120₁, . . . 120₃) thereof, characterised in that a temperature control medium flows around the electrodes (110₁, . . . 110₃, 120₁, . . . 120₃). The invention further relates to a device and to a vehicle.

### BACKGROUND OF THE INVENTION

The invention is based on a method or a device for regulating the temperature of battery cells which each comprise a first electrode in the form of a first housing shell and a second electrode in the form of a second housing shell and are electrically connected to one another via their electrodes. The invention also relates to a vehicle.

DE 10 2014 204 245 which was not yet published on the filing date of the invention relates to an energy storage unit having a plurality of galvanic cells, the galvanic cells each having a first outer side comprising a first electrode and a second outer side comprising a second electrode, and the galvanic cells being electrically connected to one another via the electrodes by stringing together the galvanic cells by way of the outer sides. The energy storage unit also comprises a first frame element and a second frame element which are directly or indirectly connected to one another, the first frame element being arranged at one end of the string of the galvanic cells and the second frame element being arranged at the other end of the string of the galvanic cells.

US 2014/038010 A1 discloses a battery pack having a multiplicity of battery cell units which are generally stacked parallel to one another. The battery cell units are configured to define converging air flow spaces between them. An air inlet head provides a converging air inlet chamber which is arranged adjacent to one side of the battery cell units, and an air outlet head provides a diverging air exit chamber which is arranged adjacent to an opposite side of the battery cell units. A blower or fan drives air into the air inlet chamber. The air flows through the air flow spaces between the battery cell units in order to cool the battery cell units. The speed of the air increases while it moves through the air inlet chamber and the plurality of air flow spaces.

US 2006/0115720 A1 discloses a battery module comprising battery units which are spatially spaced apart from one another and have defined a coolant flow path in the space. The battery module comprises a dividing rib which is arranged between the battery units, the dividing rib having a multiplicity of projections which are connected to one another.

US 2013/115489 A1 discloses a battery comprising a housing and a multiplicity of galvanic cells which are arranged in the housing. A fan is additionally arranged in the housing in order to produce a fluid flow which circulates inside the housing. According to the invention, a heat exchanger having a feed flow and a return flow for a heat carrier medium, which lead out of the housing, is arranged in the flow path of the fluid flow.

DE 10 2014 204 245 which was not yet published on the filing date of the invention discloses an energy storage unit having a plurality of galvanic cells, the cells each comprising outer contacts integrated in a cell housing (nutshell cells) and the end plates comprising integrated contact plates or printed circuit boards.

### SUMMARY OF THE INVENTION

The method and the device of the invention have the advantage that the temperature of the battery cells, for example flat battery cells and nutshell cells, can be regulated, that is to say cooled or heated, via their electrodes. The structure of a battery pack, battery module or battery system can therefore be simplified. This makes it possible to reduce weight and/or costs.

If the temperature regulation medium turbulently flows around the electrodes, this has the advantage that the heat exchange between the temperature regulation medium and the electrodes can be improved. The temperature regulation, that is to say cooling or heating, of the battery cells can therefore be improved.

If the temperature regulation medium comprises a gas, gas mixture or air, this has the advantage that the structure of the battery pack, battery module or battery system can be simplified further. Furthermore, corrosion of the battery pack, battery module or battery system can be reduced. In addition, leakage of the battery pack, battery module or battery system can be prevented. In this case, an open temperature regulation medium circuit can be achieved. The open temperature regulation medium circuit may comprise a filter such as an air filter. Alternatively, a closed temperature regulation medium circuit can be achieved. The closed temperature regulation medium circuit may comprise a heat exchanger.

If the temperature regulation medium respectively flows around a contact region of the electrodes, this has the advantage that the heat exchange between the temperature regulation medium and the electrodes can be improved further. In this case, a gap between the electrodes of two battery cells arranged adjacent to one another may comprise a distance of 1 mm to 3 mm, such as 2 mm, for example.

If a cell connector for electrically connecting the first electrode and the second electrode, comprising elevations for spacing apart the contact region of the first electrode and the contact region of the second electrode, is respectively arranged between the contact regions of the first electrodes and the contact regions of the second electrodes, this has the advantage that the temperature regulation medium can flow around the contact regions of the electrodes in an improved manner. Furthermore, the structure of the battery pack, battery module or battery system can be varied as required by selecting the cell connector from a multiplicity of different cell connectors.

If the contact regions of the first electrodes each comprise elevations for spacing apart the contact regions of the first electrodes from the contact regions of the second electrodes, this has the advantage that the temperature regulation medium can flow around the contact regions of the electrodes in an improved manner. Furthermore, the number of components and/or the number of electrical connections or contacts can be reduced. The reliability or operational safety of the battery pack, battery module or battery system can therefore be increased.

If the elevations are punctiform, burled, rod-shaped, ribbed, wave-like or sinusoidal, this has the advantage that a flow resistance of the temperature regulation medium can be reduced.

If the elevations are elastic or resilient, this has the advantage that the electrical connection can be improved. The reliability or operational safety of the battery pack, battery module or battery system can therefore be increased further. Furthermore, mechanical bracing of the battery cells can be provided. The ageing of the battery cells can therefore be reduced and the service life of the battery cells can be increased.

If the temperature regulation medium respectively flows around an edge region of the electrodes, this has the advantage that the battery cells can be arranged electrode on electrode. As a result, the dimensions of the battery pack, battery module or battery system can be reduced or minimized.

If the temperature regulation medium is respectively supplied to the edge regions of the electrodes through an outlet, this has the advantage that the temperature regulation medium can flow away in an improved manner after heat exchange.

The vehicle may be, for example, in the form of a motor vehicle such as an electric vehicle, a hybrid vehicle, a plug-in hybrid vehicle, an electric motorcycle (electro-bike, e-bike) or an electric bicycle (pedal electric cycle, Pedelec), a sea-going vessel such as an electric boat or submarine (U-boat), an aircraft or a spacecraft.

### BRIEF DESCRIPTION OF THE DRAWINGS

Exemplary embodiments of the invention are illustrated in the drawing and are explained in more detail in the following description.

FIG. 1 shows an exemplary side view of a battery module 10 according to one embodiment of the invention,

FIG. 2 shows an exemplary plan view of a battery pack 20 according to one embodiment of the invention,

FIG. 3 shows an exemplary plan view of a battery pack 30 according to another embodiment of the invention,

FIG. 4 shows an exemplary lateral sectional view of a battery module 40 according to another embodiment of the invention, and

FIG. 5 shows an exemplary lateral sectional view of a battery module 50 according to another embodiment of the invention.

### DETAILED DESCRIPTION

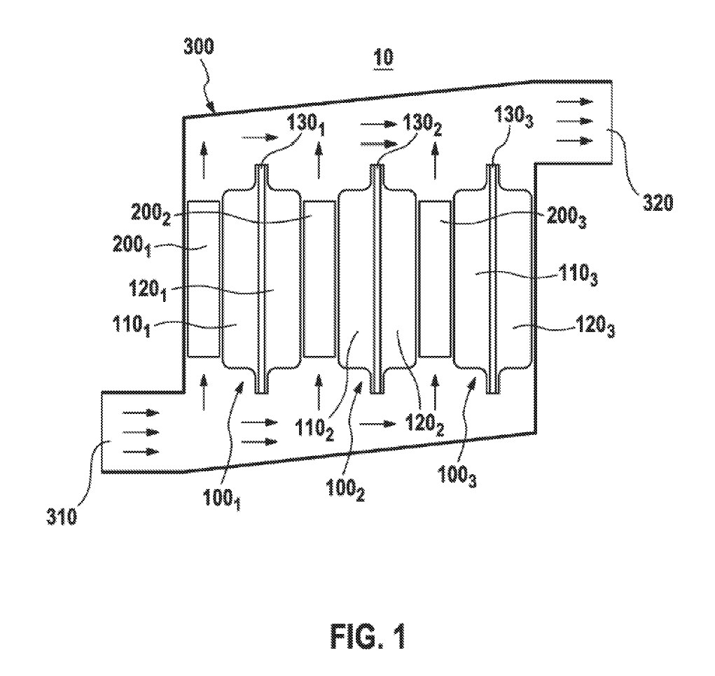

FIG. 1 shows an exemplary side view of a battery module 10 according to one embodiment of the invention.

The battery module 10 comprises a multiplicity of battery cells 100₁, . . . 100₃, a multiplicity of spacing devices 200₁, . . . 200₃ and a housing 300.

The battery cells 100₁, . . . 100₃ are in the form of nutshell cells. The nutshell cells 100₁, . . . 100₃ can each be, for example, in the form of a prism, a cuboid or a square plate, that is to say a special cuboid with exactly two identical edge lengths (a=b>c). The nutshell cells 100₁, . . . 100₃ each comprise a first electrode 110₁, . . . 110₃ which is in the form of a first housing shell or housing half-shell, a second electrode 120₁, . . . 120₃ which is in the form of a second housing shell or housing half-shell, and an insulator element 130₁, . . . 130₃ which mechanically connects the first electrode 110₁, . . . 110₃ and the second electrode 120₁, . . . 120₃ to one another and electrically insulates them from one another. The first electrode 110₁, . . . 110₃ and the second electrode 120₁, . . . 120₃ may be, for example, in the form of a metal sheet, a metal film or a metallized film and/or may be formed by means of a deep-drawing method. The insulator element 130₁, . . . 130₃ may be in the form of a seal or sealing ring, for example, and/or may be fully connected, for example adhesively bonded, to the first electrode 110₁, . . . 110₃ and the second electrode 120₁, . . . 120₃ or their edge regions or lugs. The battery cells 100₁, . . . 100₃ are arranged beside one another in a manner oriented parallel to one another.

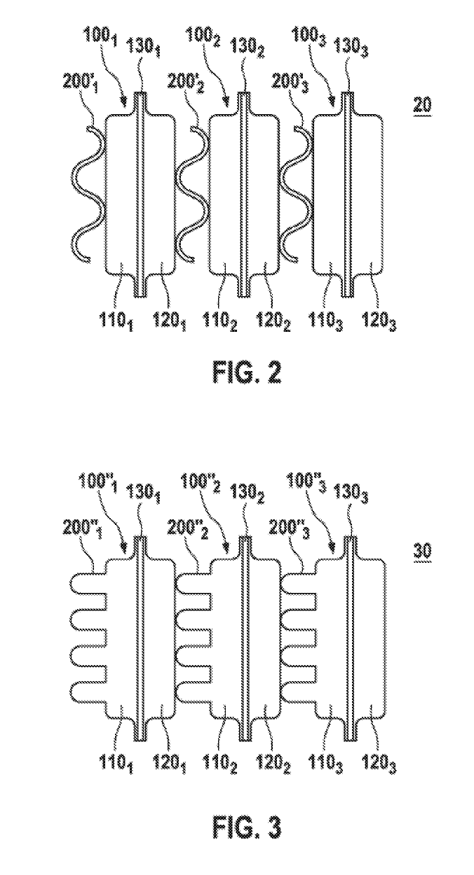

The spacing devices 200₂, 200₃ comprise an electrically conductive element or material for electrically connecting contact surfaces, for example rectangular or square contact surfaces, of the electrodes 110₁, . . . 110₃, 120₁, . . . 120₃ and respectively form a channel or a multiplicity of channels for receiving a temperature regulation medium between the first electrodes 110₁, . . . 110₃ and the second electrodes 120₁, . . . 120₃. The spacing devices 200₂, 200₃ are arranged between the electrodes 110₂, 110₃, 120₁, 120₂ of the battery cells 100₁, . . . 100₃ and respectively electrically interconnect the first electrodes 110₂, 110₃ and the second electrodes 120₁, 120₂ or their contact regions of the battery cells 100₁, . . . 100₃ arranged adjacent to one another. As shown by way of example in FIG. 1 for the battery cell 100₁, the spacing devices 200₁ may be arranged at the first electrode 110₁ of a first battery cell 100₁ and/or the second electrode 120₃ of a last battery cell 100₃ of the multiplicity of battery cells 100₁, . . . 100₃, that is to say at only one electrode. Embodiments of the spacing devices 200₁, . . . 200₃ are described with reference to FIGS. 2 and 3.

The housing encloses the battery cells 100₁, . . . 100₃ and spacing devices 200₁, . . . 200₃. As shown by way of example in FIG. 1, the housing 300 may comprise a temperature regulation device comprising an inlet opening or an inlet 310 for introducing the temperature regulation medium and an outlet opening or an outlet 320 for discharging the temperature regulation medium after heat exchange. The temperature regulation medium can flow around the first electrodes 110₁, . . . 110₃ and the second electrodes 120₁, . . . 120₃ and can therefore regulate the temperature of the battery cells 100₁, 100₃.

FIG. 2 shows an exemplary plan view of a battery pack 20 according to one embodiment of the invention.

The battery pack 20 comprises a multiplicity of battery cells 100₁, . . . 100₃ and a multiplicity of cell connectors 200′₁, . . . 200′₃.

The cell connectors 200′₁, . . . 200′₃ implement the spacing devices 200₁, . . . 200₃ described with reference to FIG. 1. The cell connectors 200′₁, . . . 200′₃ are in the form of rectangular or square cell connectors and comprise a metal sheet which is sinusoidally bent. The cell connectors 200′₁, . . . 200′₃ make contact with the contact surfaces of the electrodes 110₁, . . . 110₃, 120₁, . . . 120₃ and respectively electrically interconnect adjacently arranged electrodes 120₁ to 110₂ and 120₂ to 110₃. In this case, the metal sheets respectively subdivide the spaces between the electrodes 120₁, 110₂ and 120₂, 110₃ into a multiplicity of channels for receiving the temperature regulation medium, which, with reference to FIG. 1, extend from the bottom, that is to say on the side of the inlet opening 310, to the top, that is to say on the side of the outlet opening 320, in the flow direction of the temperature regulation medium. The elevations 200″₁, . . . 200″₂ also increase the size of the temperature regulation surfaces or cooling surfaces of the spaces between the electrodes 120₁, 110₂ and 120₂, 110₃.

FIG. 3 shows an exemplary plan view of a battery pack 30 according to another embodiment of the invention.

The battery pack 30 comprises a multiplicity of battery cells 100″₁, . . . 100″₃.

The battery cells 100″₁, . . . 100″₃ correspond substantially to the battery cells 100₁, . . . 100₃ described with reference to FIG. 1.

A multiplicity of elevations 200″₁, . . . 200″₂ on the first electrodes 110₁, . . . 110₃ of the battery cells 100″₁, . . . 100″₃ implement the spacing devices 200₁, . . . 200₃ described with reference to FIG. 1. The elevations 200″₁, . . . 200″₂ are in the form of ribs on the first electrodes 110₁, . . . 110₃. One or more of the multiplicity of elevations 200″₁, . . . 200″₂ make contact with the contact surfaces of the second electrodes 120₁, . . . 120₃ and respectively electrically interconnect adjacently arranged electrodes 120₁ to 110₂ and 120₂ to 110₃. In this case, the elevations 200″₁, . . . 200″₂ respectively subdivide the spaces between the electrodes 120₁, 110₂ and 120₂, 110₃ into a multiplicity of channels for receiving the temperature regulation medium, which, with reference to FIG. 1, extend from the bottom, that is to say on the side of the inlet opening 310, to the top, that is to say on the side of the outlet opening 320, in the flow direction of the temperature regulation medium.

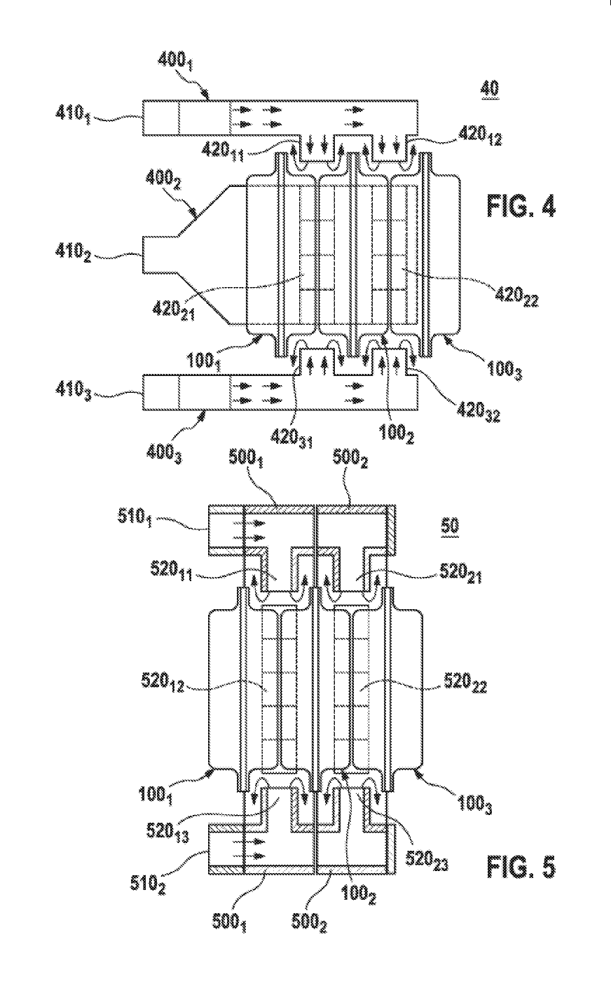

FIG. 4 shows an exemplary lateral sectional view of a battery module 40 according to another embodiment of the invention.

The battery module 40 comprises a multiplicity of battery cells 100₁, . . . 100₃ and a multiplicity of temperature regulation devices 400₁, . . . 400₃.

The battery cells 100₁, . . . 100₃ correspond to the battery cells 100₁, . . . 100₃ described with reference to FIG. 1. The battery cells 100₁, . . . 100₃ are arranged next to one another in a manner oriented parallel to one another. The contact surfaces of the first electrodes 110₂, 110₃ respectively make contact with the contact surfaces of the second electrodes 120₁, 120₂ and respectively electrically interconnect adjacently arranged electrodes 120₁ to 110₂ and 120₂ to 110₃.

The temperature regulation devices 400₁, . . . 400₃ each comprise an inlet opening 410₁, . . . 410₃ and a multiplicity of outlet openings 420₁₁, . . . 420₃₂. The temperature regulation devices 400₁, . . . 400₃ are arranged axially around the multiplicity of battery cells 100₁, . . . 100₃, that is to say one temperature regulation device 400₁, . . . 400₃ at the top, at the rear, at the bottom and at the front in each case (temperature regulation device at the front not shown). In this case, the outlet openings 420₁₁, . . . 420₃₂ are each arranged centrally, that is to say above the contact surfaces.

As illustrated in FIG. 4 by means of arrows, the temperature regulation devices 400₁, . . . 400₃ respectively distribute the temperature regulation medium supplied through the inlet openings 410₁, . . . 410₃ to the outlet openings 420₁₁, 420₁₂; 420₂₁, 420₂₂ or 420₃₁, 420₃₂ and guide the distributed temperature regulation medium from the outlet openings 420₁₁, 420₁₂; 420₂₁, 420₂₂ or 420₃₁, 420₃₂ to the edge regions of the electrodes of the multiplicity of battery cells 100₁, . . . 100₃. As shown by way of example in FIG. 4 for the outlet openings 420₂₁, 420₂₂, the outlet openings 420₁₁, . . . 420₃₂ may be subdivided into a multiplicity of outlet nozzles. The temperature regulation medium can flow away in the direction of the arrows after heat exchange.

FIG. 5 shows an exemplary lateral sectional view of a battery module 50 according to another embodiment of the invention.

The battery module 50 comprises a multiplicity of battery cells 100₁, . . . 100₃ and a multiplicity of temperature regulation devices 500₁, 500₂.

The battery cells 100₁, . . . 100₃ correspond to the battery cells 100₁, . . . 100₃ described with reference to FIG. 1. As described with reference to FIG. 4, the battery cells 100₁, . . . 100₃ are arranged next to one another in a manner oriented parallel to one another. The contact surfaces of the first electrodes 110₂, 110₃ respectively make contact with the contact surfaces of the second electrodes 120₁, 120₂ and respectively electrically interconnect adjacently arranged electrodes 120₁ to 110₂ and 120₂ to 110₃.

The temperature regulation devices 500₁, 500₂ comprise a multiplicity of inlet openings 510₁, . . . 510₂ and each comprise a multiplicity of outlet openings 520₁₁, . . . 520₂₃. The temperature regulation devices 500₁, 500₂ are arranged radially around the multiplicity of battery cells 100₁, . . . 100₃, that is to say one temperature regulation device 500₁, 400₂ on the left and on the right in each case. In this case, the outlet openings 520₁₁, . . . 520₂₃ are each arranged centrally, that is to say above the contact surfaces.

As illustrated in FIG. 5 by means of arrows, the temperature regulation devices 500₁, 500₂ respectively distribute the temperature regulation medium supplied through the inlet openings 510₁, 510₂ to the outlet openings 520₁₁, . . . 520₁₃ or 520₂₁, . . . 520₂₃ (outlet openings at the front not shown) and guide the distributed temperature regulation medium from the outlet openings 520₁₁, . . . 520₁₃ or 520₂₁, . . . 520₂₃ to the edge regions of the electrodes of the multiplicity of battery cells 100₁, . . . 100₃. As shown by way of example in FIG. 5 for the outlet openings 520₁₂, 520₂₂, the outlet openings 520₁₁, . . . 520₂₃ can be subdivided into a multiplicity of outlet nozzles. The temperature regulation medium can flow away in the direction of the arrows after heat exchange.

1. A method for regulating the temperature of battery cells (100₁, . . . 100₃; 100″₁, . . . 100″₃) which each comprise a first electrode (110₁, . . . 110₃) in the form of a first housing shell and a second electrode (120₁, . . . 120₃) in the form of a second housing shell and are electrically connected to one another via their electrodes (110₁, . . . 110₃, 120₁, . . . 120₃), the method comprising:
providing a temperature regulation medium flowing around the electrodes (110₁, . . . 110₃, 120₁, . . . 120₃).

2. The method as claimed in claim 1, wherein:
the temperature regulation medium turbulently flows around the electrodes (110₁, . . . 110₃, 120₁, . . . 120₃).

3. The method as claimed in claim 1, wherein:
the temperature regulation medium comprises a gas, gas mixture or air.

4. The method as claimed in claim 1, wherein:
the temperature regulation medium respectively flows around a contact region of the electrodes (110₁, . . . 110₃, 120₁, . . . 120₃).

5. The method as claimed in claim 4, wherein:
a cell connector (200′₁, . . . 200′₃) for electrically connecting the first electrode (110₁, . . . 110₃) and the second electrode (120₁, . . . 120₃), comprising elevations (200₁, . . . 200₃) for spacing apart the contact region of the first electrode (110₁, . . . 110₃) and the contact region of the second electrode (120₁ . . . 120₃), is respectively arranged between the contact regions of the first electrodes (110₁, . . . 110₃) and the contact regions of the second electrodes (120₁ . . . 120₃), with the result that the temperature regulation medium can flow around the contact regions of the electrodes (110₁, . . . 110₃, 120₁, . . . 120₃).

6. The method as claimed in claim 4, wherein:
the contact regions of the first electrodes (110₁, . . . 110₃) each comprise elevations (200₁, . . . 200₃, 200″₁, . . . 200″₃) for spacing apart the contact regions of the first electrodes (110₁, . . . 110₃) from the contact regions of the second electrodes (120₁ . . . 120₃), with the result that the temperature regulation medium can flow around the contact regions of the electrodes (110₁, . . . 110₃, 120₁, . . . 120₃).

7. The method as claimed in claim 5, wherein:
the elevations (200₁, . . . 200₃) are punctiform, burled, rod-shaped, ribbed, wave-like or sinusoidal.

8. The method as claimed in claim 1, wherein:
the temperature regulation medium respectively flows around an edge region of the electrodes (110₁, . . . 110₃, 120₁, . . . 120₃).

9. The method as claimed in claim 8, wherein:
the temperature regulation medium is respectively supplied through an outlet (420₁₁, . . . 420₃₂; 520₁₁, . . . 520₂₃) to the edge regions of the electrodes (110₁, . . . 110₃, 120₁, . . . 120₃), with the result that the temperature regulation medium can flow around the edge regions of the electrodes (110₁, . . . 110₃, 120₁, . . . 120₃).

10. A device for regulating the temperature of battery cells (100₁, . . . 100₃; 100″₁, . . . 100″₃) which each comprise a first electrode (110₁, . . . 110₃) in the form of a first housing shell and a second electrode (120₁, . . . 120₃) in the form of a second housing shell and are electrically connected to one another via their electrodes (110₁, . . . 110₃, 120₁, . . . 120₃), characterized in that:
a temperature regulation medium flows around the electrodes (110₁, . . . 110₃, 120₁, . . . 120₃).

11. The device as claimed in claim 10, wherein:
the temperature regulation medium turbulently flows around the electrodes (110₁, . . . 110₃, 120₁, . . . 120₃).

12. The device as claimed in claim 10, wherein:
the temperature regulation medium comprises a gas, gas mixture or air.

13. The device as claimed in claim 10, wherein:
the temperature regulation medium can respectively flows around a contact region of the electrodes (110₁, . . . 110₃, 120₁, . . . 120₃).

14. The device as claimed in claim 13, wherein:
a cell connector (200′₁, . . . 200′₃) for electrically connecting the first electrode (110₁, . . . 110₃) and the second electrode (120₁ . . . 120₃), comprising elevations (200₁, . . . 200₃) for spacing apart the contact region of the first electrode (110₁, . . . 110₃) and the contact region of the second electrode (120₁ . . . 120₃), is respectively arranged between the contact regions of the first electrodes (110₁, . . . 110₃) and the contact regions of the second electrodes (120₁, . . . 120₃), with the result that the temperature regulation medium can flow around the contact regions of the electrodes (110₁, . . . 110₃, 120₁, . . . 120₃).

15. The device as claimed in claim 13, wherein:
the contact regions of the first electrodes (110₁, . . . 110₃) each comprise elevations (200₁, . . . 200₃, 200″₁, . . . 200″₃) for spacing apart the contact regions of the first electrodes (110₁, . . . 110₃) from the contact regions of the second electrodes (120₁, . . . 120₃), with the result that the temperature regulation medium can flow around the contact regions of the electrodes (110₁, . . . 110₃, 120₁, . . . 120₃).

16. The device as claimed in claim 14, wherein:
the elevations (200₁, . . . 200₃) are punctiform, burled, rod-shaped, ribbed, wave-like or sinusoidal, or
the elevations (200₁, . . . 200₃) are elastic or resilient.

17. The device as claimed in claim 10, wherein:
the temperature regulation medium can respectively flow around an edge region of the electrodes (110₁, . . . 110₃, 120₁, . . . 120₃).

18. The device as claimed in claim 17, wherein:
the temperature regulation medium can be respectively supplied through an outlet (420₁₁, . . . 420₃₂; 520₁₁, . . . 520₂₃) to the edge regions of the electrodes (110₁, . . . 110₃, 120₁, . . . 120₃), with the result that the temperature regulation medium can flow around the edge regions of the electrodes (110₁, . . . 110₃, 120₁, . . . 120₃).

19. A vehicle comprising:
the device as claimed in claim 10.

20. The method as claimed in claim 5, wherein:
the elevations (200₁, . . . 200₃) are elastic or resilient.
